(19) United States
(12) Patent Application Publication
(10) Pub. No.: US 2018/0153083 A1
(43) Pub. Date: Jun. 7, 2018

(54) Water Shovel

(71) Applicant: Wissam Aoun, Windsor (CA)

(72) Inventor: Wissam Aoun, Windsor (CA)

(21) Appl. No.: 15/366,886

(22) Filed: Dec. 1, 2016

(51) Int. Cl. A01B 1/02

(52) U.S. Cl. CPC A01B 1/022; A01B 1/06

(57) ABSTRACT

The water shovel is a device which allows the user to soften hard soil before or upon breaking the surface of the soil and reduces the problem of airborne dust created by excavating. The water shovel comprises a handle which houses a containment chamber, and a liquid discharge mechanism disposed on the handle to regulate flow of liquid from the containment chamber to a discharge conduit. The liquid from the containment chamber is expelled through the discharge conduit disposed on a digging implement which contacts the soil when the shovel is used for digging. The first end of the handle is threaded, whereby it can be covered with a cap or connected to an external water supply source such as a hose which continuously fills the containment chamber. The water shovel may also be used for other applications such as snow and ice removal by substituting a de-icing solution in place of water.

### BACKGROUND

The present invention relates to manual excavation devices, and more particularly shovels used for digging and moving substrate materials.

A shovel is a common tool used to excavate soil from the ground, however it may also be used for other purposes like snow removal or transferring coal into a steam engine train. In many of these applications, there may be a need for a liquid to be discharged onto the substrate material that the shovel intends to move in order to ease the process.

Although various shovel-like objects have a liquid discharge system, a liquid containment chamber or liquid discharge activation mechanism, such devices do not provide a solution that allows a user to selectively use the device with or without a liquid supply source source, such as a hose, connected to it. Thus, there is an absence of devices that allow for use both, with a liquid supply source connection as well as connection free use of the device. In addition, the existing systems discharge liquid in a fashion akin to a spray originating at a point removed from the area where the shovel contacts the ground, rather than at or near the point where the shovel contacts the ground which allows for more precision in the application of the liquid to the ground.

### BRIEF SUMMARY

The present invention is directed to a shovel that provides the user with the ability to soften hard ground, by the application of water, to make excavation easier and also reduce the problem of airborne dust created while digging. In addition, the user has the flexibility to use the shovel independently or while connected to a water supply source.

A shovel having features of the present invention comprises a handle with a first and second end, the first end having an opening. The handle encloses a containment chamber located between the two ends of the handle, where the containment chamber is connected to the opening in the first end of the handle. The second end of the handle is connected to a digging implement which may include: a shovel head, plow head or other implement for digging. A discharge conduit is disposed on the digging implement and is connected to the containment chamber at the second end of the handle to allow water to flow from the containment chamber onto the digging implement to soften the material that needs excavation. The discharge conduit is disposed upon the digging implement to direct the liquid to the ground with precision.

The inner and outer surfaces of the first end of the handle can be threaded, so that the first end can be covered with a cap or connected to a water supply source, a hose for example. This allows the user the flexibility of using the shovel with a water supply source which continually fills the containment chamber, or provides the user with the option to use the shovel independent of the water supply source so to increase the range of motion in alternative usage situations.

The digging implement can also contain channels which are in connection with the discharge conduit. The channels allow the water to be discharged close to where the implement contacts the ground, allowing for more precision when directing the water to the ground.

The shovel may also have a discharge activation mechanism that allows the user to control the discharge of water from the containment chamber to the discharge conduit. This allows the user to start and stop the application of water to the ground or use the shovel as a conventional shovel without water. Preferably, the discharge activation mechanism is a one-way valve system that is spring biased. This valve, when operably connected to the discharge conduit, allows the user to accurately control the flow of liquid from the containment chamber to the ground with precision as to provide the correct amount of dampness to allow for efficient removal of the soil without creating mud.

In addition to water, other liquids may also be used with the water shovel. For example a solution of water and fertilizer may be applied to soil using the water shovel. Also, the water shovel may be used with for other applications than digging. For example, the shovel may be used to remove snow and ice by substituting a de-icing solution in place of water.

These and other features, aspects and advantages of the water shovel will become better understood with regard to the following description, appended claims and accompanying drawings.

### BRIEF DESCRIPTION OF THE DRAWINGS

To easily identify the discussion of any particular element or act, the most significant digit or digits in a reference number refer to the figure number in which that element is first introduced.

FIG. 1 Illustrates an environmental perspective view of a water shovel, embodying features of the invention.

FIG. 2 Illustrates a cut-away side view of the water shovel embodying features of the invention.

FIG. 3 Illustrates a magnified cut-away view of the discharge activation mechanism of FIGS. 1 and 2.

FIG. 4 Illustrates a side view of another version of the discharge activation mechanism, according the to invention.

FIG. 5 Illustrates a top view of a water shovel, in accordance with an embodiment of the invention.

FIG. 6 Illustrates a magnified cut-away view of the first end of the handle of the water shovel of FIG. 2.

FIG. 7 Illustrates an environmental perspective view of a water shovel, according to the present invention, where the first end is covered by a cap.

FIG. 8 Illustrates an environmental perspective view of a water shovel, according to the present invention, where the first end is connected to a hose.

FIG. 9 Illustrates a cut-away view of a water shovel according the to present invention, where the first end is covered by a cap with a plunger.

### DESCRIPTION

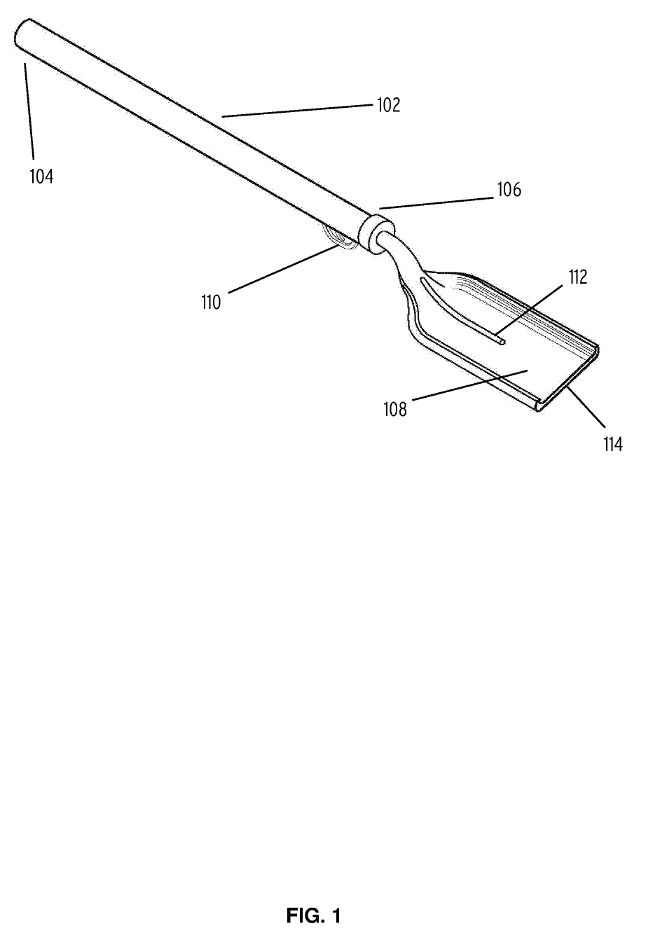

Now referring to FIG. 1, a water shovel comprises a handle 102 with a first end 104 and a second end 106 that is connected to a digging implement 108 with a discharge conduit 112 disposed on the digging implement 108. A discharge activation mechanism 110 is also present on the handle. In the preferred embodiment depicted in FIG. 1, the discharge activation mechanism 110 is situated adjacent to the digging implement 108 at the second end of the handle 106. In other embodiments, the discharge activation mechanism may be at any point along the handle.

Disposed on the digging implement 108 is a discharge conduit 112 which directs water from the shovel to flow accurately towards the end of the digging implement 114 which contacts the ground upon use. The discharge conduit may also comprise a spray nozzle disposed upon the digging implement to increase the range of water application in a precise area (not shown). The water shovel can also be modular so to exchange different digging implements for different applications. It should be noted that the shovel head depicted as the digging implement 108 in FIG. 1, may be substituted for any digging implement or gardening tool designed to manipulate soil, with a discharge conduit adapted to those particular embodiments.

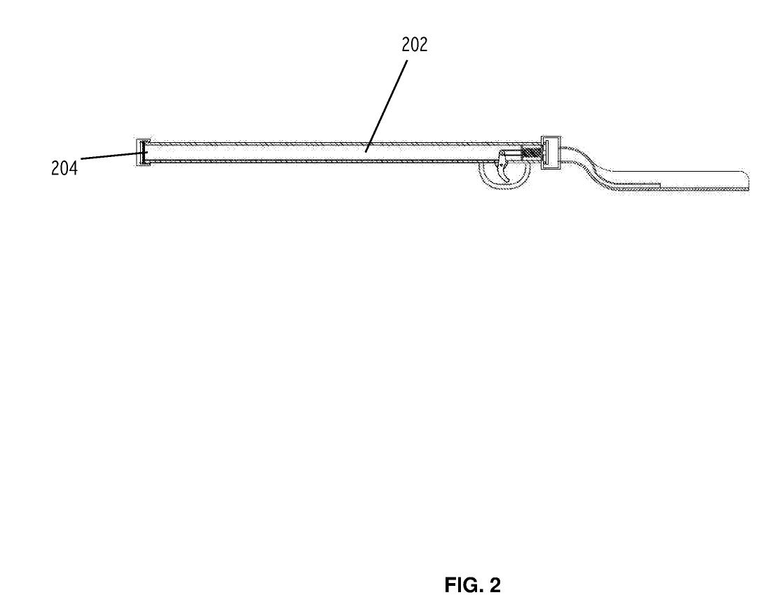

As shown in FIG. 2, the handle of the water shovel encloses a containment chamber 202 in fluidic connection with the opening in the first end of the handle 204. This allows for the containment chamber 202 to be filled with liquid through the opening in the first end of the handle 204. The water shovel, while primarily designed to be used with hardened soil, can be used for other purposes where liquids need be applied to various substrate materials.

Another contemplated application would be using the water shovel for hardened snow and ice removal, where water may be substituted for a liquid de-icer solution. Thus, the water shovel will work with liquids with substantially similar viscosities to water and this allows for multiple usage scenarios where a liquid solution that is slightly more or less viscous than water may be required. For example, a water solution containing fertilizer or pesticide may be applied to soil using the water shovel.

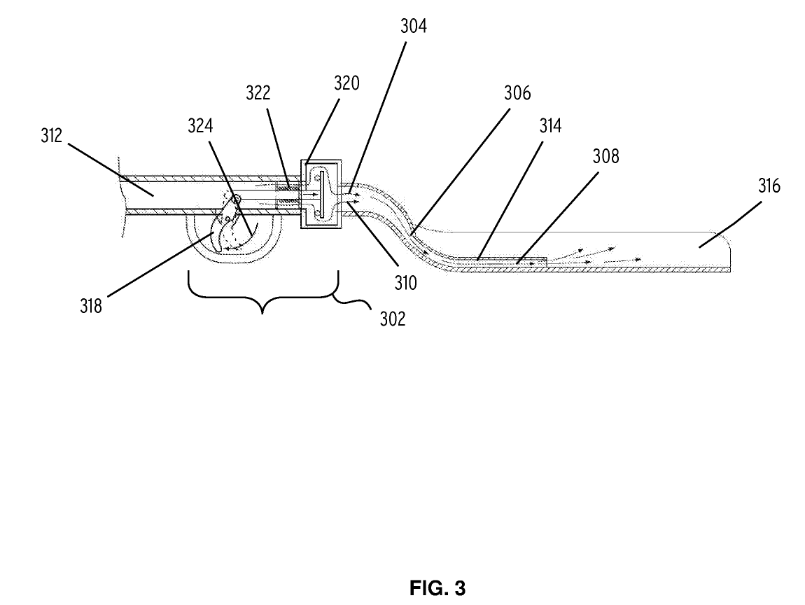

Now referring to FIG. 3, the discharge activation mechanism 302 regulates the flow of liquid (indicated by arrows 304, 306, 308, 310) from the containment chamber 312 to the discharge conduit 314. This allows for precise amounts of liquid to be discharged onto the desired spot for easier manual excavation of soil. Applying a precise amount of liquid is crucial, as over application would make excavation of the dried soil more difficult, as the mud that results from over application is heavy and difficult to manage as it can stick to the digging implement 316. Also, the water shovel may be used as a conventional shovel with no liquid flowing from the discharge conduit 314 if desired.

In one embodiment shown in FIG. 3, the discharge activation mechanism 302 comprises a trigger 318 operably connected to a one-way valve 320 such that the fluid containment chamber 312, the one-way valve 320, and the discharge conduit 314 are all in fluidic connection. The one-way valve comprises a spring 322 that opens and closes the one-way valve 320 to allow liquid to pass through. The trigger 318, when in the depressed position (indicated by arrow 324), changes the load on the spring 322, which has the effect of changing the position of the one-way valve 320 from closed to open. A spring loaded, one-way valve 320 depicted in FIG. 3 is the preferred embodiment, however, it may be substituted for other methods that are not spring loaded valves such as a gate valve (not shown).

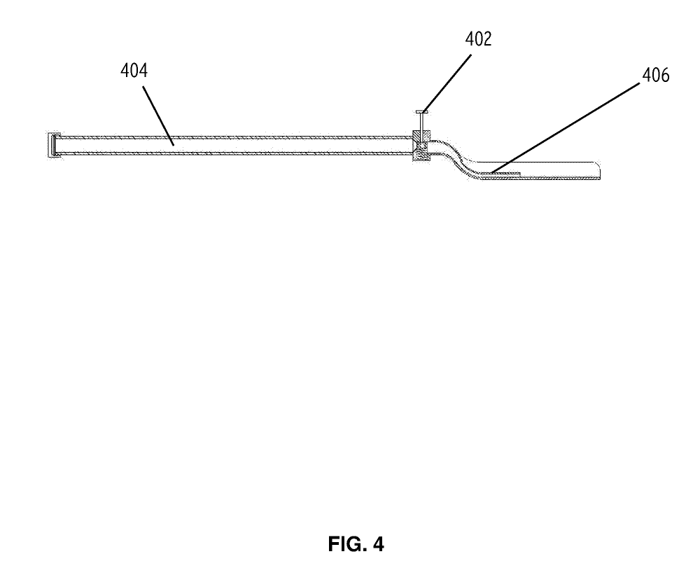

As shown in FIG. 4, another version of the discharge activation mechanism may be a push button actuation system 402 to control the flow of liquid from the containment chamber 404 to the discharge conduit 406 in the same fashion as the trigger 318 in FIG. 3. While only a trigger 318 (FIG. 3) and push button (FIG. 4) 402 have been shown for exemplary purposes, alternative discharge activation mechanisms that achieve the same function are contemplated.

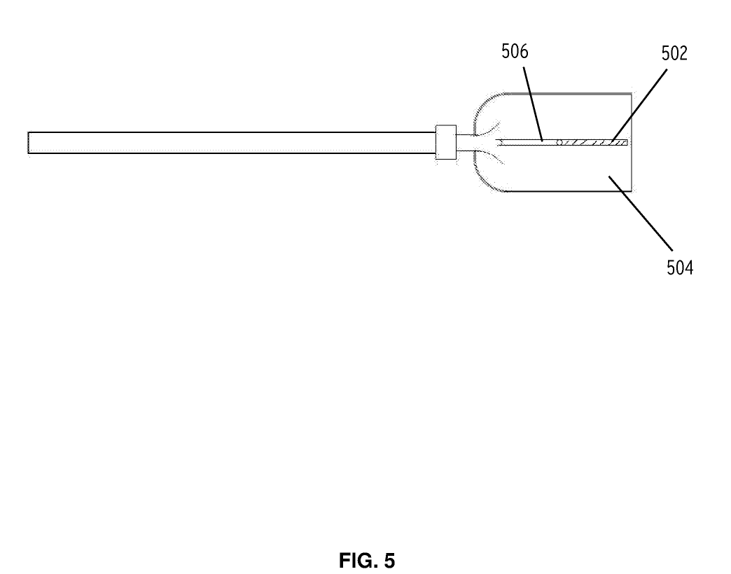

FIG. 5 shows one embodiment of the water shovel with a channel 502 in the digging implement 504, being in connection with the discharge conduit 506. While only a single channel 502 is shown for illustration purposes, it is contemplated that other embodiments may contain a plurality of channels in the digging implement in connection with the discharge conduit. The inclusion of a channel 502 in the digging implement 504 allows for increased precision in application of water to the soil.

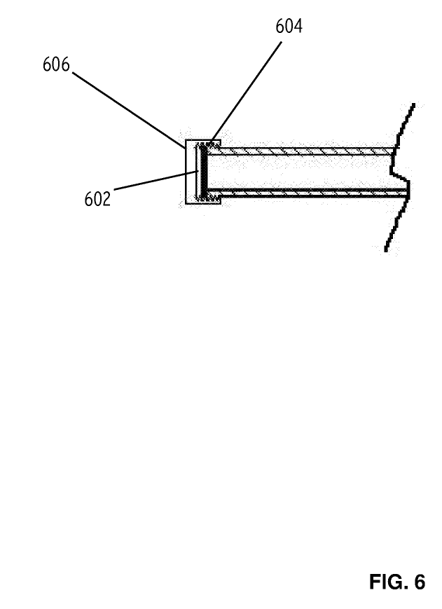

Now referring to FIG. 6, in certain embodiments of the water shovel, the opening in the first end of the handle 602 has an outer peripheral surface 604 which is threaded. This allows for the opening to be covered with a cap 606. The cap 606 is designed so to thread into the threads on the outer peripheral surface 604 to form a liquid tight seal. This allows for a wide range of motion and portability without liquid spillage when using the water shovel to move loosened soil.

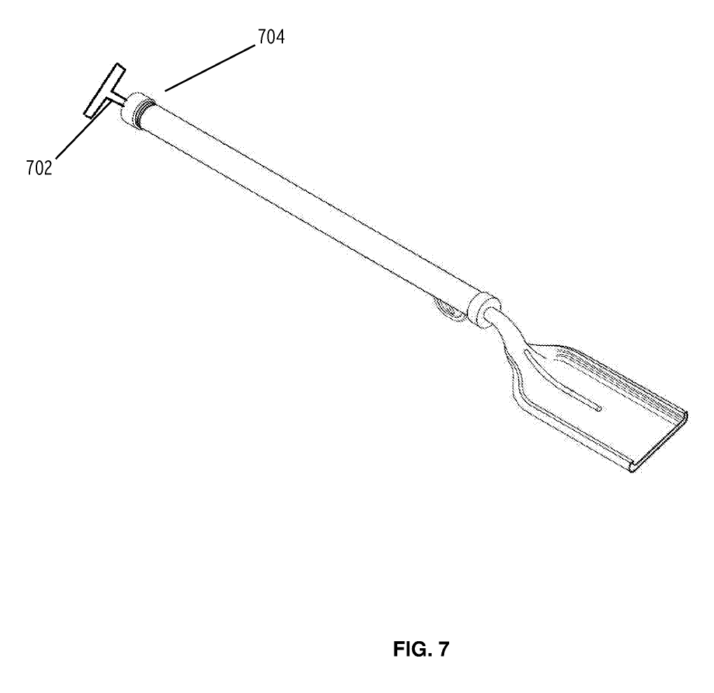

As shown in FIG. 7, the cap 702 may be shaped to allow a user to easily grip the first end of the handle 704 in a similar way that a conventional shovel would be gripped.

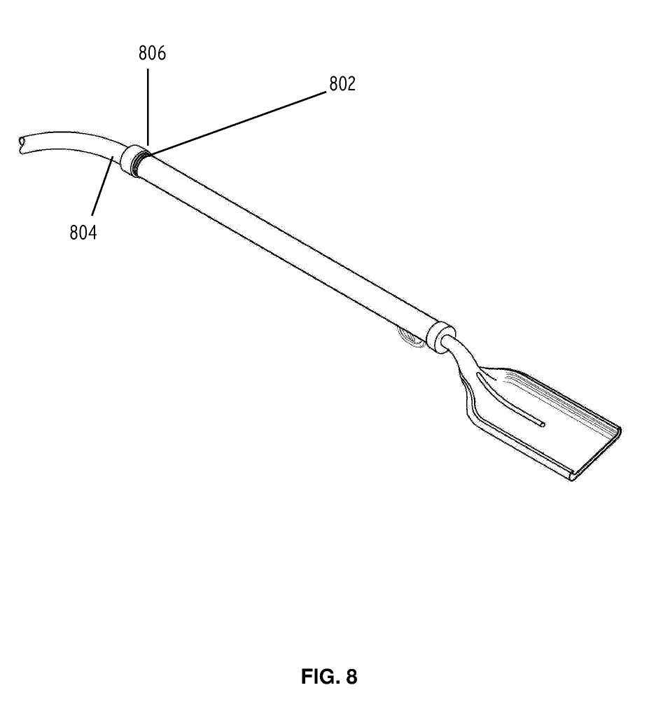

In another embodiment shown in FIG. 8, the threaded outer peripheral surface 802 allows for an external liquid supply source, a hose 804, to be connected to the first end of the handle 806. In this embodiment, the hose 804 is in fluidic connection with the opening in the first end of the handle whereby the hose continuously supplies liquid to the containment chamber. This is advantageous in that the containment chamber need not be refilled frequently.

While a hose is the preferred external liquid supply source, other sources such as a pressurized tank are also contemplated. In yet another embodiment, the opening in the first end of the handle has an inner peripheral surface which is threaded (not shown).

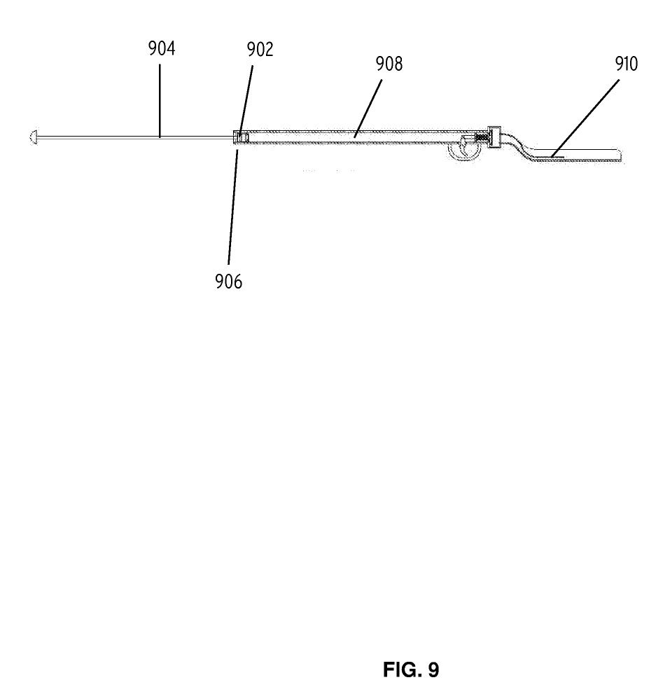

In the embodiment shown in FIG. 9, a cap 902 through which a plunger 904 passes can be connected to the first end of the handle 906. When pushed by the user, the plunger 904 passes into the containment chamber 908 expelling liquid through the discharge conduit 910. The advantage of this embodiment is that it can result in increased flow of the liquid in the containment chamber 908 by building up pressure within the containment chamber. This is particularly useful when the amount of liquid in the containment chamber 908 is low and the plunger 904 would allow the user to increase the flow back to the desired rate. Alternatively, the containment chamber 908 may only be filled with a small amount of liquid at a time, and with use of the plunger 904 still be able to expel the liquid at a steady rate.

Although the present invention has been described in considerable detail with reference to certain preferred versions thereof, other versions are possible. Therefore, the spirit and scope of the appended claims should not be limited to the description of the preferred versions contained herein.

1: A digging tool comprising:
a handle having a first end and a second end, the first end having an opening with an outer peripheral surface;
a digging implement connected to the second end of the handle;
a containment chamber, enclosed within the handle between the first and second end of the handle, the containment chamber being in fluidic connection with the opening in the first end of the handle; and
a discharge conduit disposed upon the digging implement, the discharge conduit being in fluidic connection with the containment chamber.

2: The tool according to claim 1, wherein the discharge conduit comprises a spray nozzle disposed upon the digging implement.

3: The tool according to claim 1, further comprising a discharge activation mechanism operably connected to the discharge conduit to allow a user to discharge a liquid from the containment chamber through the discharge conduit by engaging the discharge activation mechanism.

4: The tool according to claim 3, wherein the discharge activation mechanism comprises a one-way valve system disposed between the containment chamber and the discharge conduit.

5: The tool according to claim 4, wherein the one-way valve system comprises of a spring biased one-way valve comprising a spring bias compressed between a holding plate and a gate, wherein the gate is moveable between a spring biased closed position and an open position, wherein it is operably connected to the discharge activation mechanism, where compression of the discharge activation mechanism causes the valve to overcome the bias and move from the closed position to the open position to discharge from the containment chamber through a fluid pipe and out from the discharge conduit.

6: The tool according to claim 3, wherein the discharge activation mechanism comprises of any one of a trigger, a button, or a switch, when compressed by the user, discharges the liquid from the containment chamber through the discharge conduit.

7: The tool according to claim 3, wherein the discharge activation mechanism is disposed on the handle adjacent to the digging implement.

8: A digging tool comprising:
a handle having a first end and a second end, the first end having an opening with an outer peripheral surface;
a digging implement connected to the second end of the handle;
a containment chamber, enclosed within the handle between the first and second end of the handle, the containment chamber being in fluidic connection with the opening in the first end of the handle;
a discharge conduit disposed upon the digging implement, the discharge conduit being in fluidic connection with the containment chamber;
at least one channel in the digging implement, the channel being in connection with the discharge conduit; and
a discharge activation mechanism operably connected to the discharge conduit to allow a user to discharge a liquid from the containment chamber through the discharge conduit into the channel in the digging implement by engaging the discharge activation mechanism.

9: The tool according to claim 8, wherein the at least one channel are integral to the digging implement.

10: The tool according to claim 8, wherein the at least one channel are disposed on the surface of the digging implement.

11: The tool according to claim 8, wherein the discharge activation mechanism comprises a one-way valve system disposed between the containment chamber and the discharge conduit.

12: The tool according to claim 11, wherein the one-valve system comprises of a spring biased one-way valve comprising a spring bias compressed between a holding plate and a gate, wherein the gate is moveable between a spring biased closed position and an open position, wherein it is operably connected to the trigger, button, or switch, where compression of the trigger, button, or switch causes the valve to overcome the bias and move from the closed position to the open position to discharge from the containment chamber through the fluid pipe and out from the discharge conduit.

13: The tool according to claim 8, wherein the discharge activation mechanism comprises of any one of a trigger, a button, or a switch, when compressed by the user, discharges the liquid from the containment chamber through the discharge conduit.

14: The tool according to claim 8, wherein the discharge activation mechanism is disposed on the handle adjacent to the digging implement.

15: The tool according to claim 1, further comprising a cap having an open end and a closed end, the open end having an inner peripheral surface configured to removably attach to the outer peripheral surface of the first end of the handle.

16: The tool according to claim 15, wherein the open end of the cap allows a plunger to pass through, such that the plunger passes into the containment chamber when pushed by the user.

17: The tool according to claim 15, wherein the cap is shaped for gripping by a user.

18: The tool according to claim 1, wherein the outer peripheral surface of the opening in the first end of the handle is threaded for hose connections.

19: The tool according to claim 1, wherein the opening in the first end of the handle further comprises an inner peripheral surface threaded for hose connections.

20: The tool according to claim 1, wherein the digging implement comprises any one of a shovel head, a plow head, a rake head, a twist cultivator, a hoe head, or a chisel head.
